(19) United States
(12) Patent Application Publication
(10) Pub. No.: US 2007/0070342 A1
(43) Pub. Date: Mar. 29, 2007

(54) Ultrasonic spray deposition of analytes for improved molecular chemical imaging detection

(76) Inventor: Patrick J. Treado, Pittsburgh, PA (US)

Correspondence Address: DUANE MORRIS LLP, 1667 K. STREET, N.W., SUITE 700, WASHINGTON, DC, 20006-1608, US

(21) Appl. No.: 11/527,391

(22) Filed: Sep. 27, 2006

Related U.S. Application Data
(60) Provisional application No. 60/720,783, filed on Sep. 27, 2005.

(51) Int. Cl. G01J 3/44; G01N 1/00; G01N 21/65

(52) U.S. Cl. 356/301; 356/38

(57) ABSTRACT

A device and method is described that uses an ultrasonic nozzle for high efficiency deposition of an analyte. Certain embodiments include a plurality of spray applications over the same spatial location to thereby increase the analyte concentration so as to localize and improve the overall molecular chemical imaging sensitivity and specificity. A spectral analysis of the analyte may be conducted and compared with the spectra of biothreat agents.

### RELATED APPLICATIONS

The present application hereby incorporates by reference in its entirety and claims priority benefit from U.S. Provisional Patent Application Ser. No. 60/720,783 filed 27 Sep. 2005.

### BACKGROUND

Spectroscopic imaging combines digital imaging and molecular spectroscopy techniques, which can include Raman scattering, fluorescence, photoluminescence, ultraviolet, visible and infrared absorption spectroscopes. When applied to the chemical analysis of materials, spectroscopic imaging is commonly referred to as chemical imaging. Instruments for performing spectroscopic (i.e. chemical) imaging typically comprise image gathering optics, focal plane array imaging detectors and imaging spectrometers.

In general, the sample size determines the choice of image gathering optic. For example, a microscope is typically employed for the analysis of sub micron to millimeter spatial dimension samples. For larger objects, in the range of millimeter to meter dimensions, macro lens optics are appropriate. For samples located within relatively inaccessible environments, flexible fiberscopes or rigid borescopes can be employed. For very large scale objects, such as planetary objects, telescopes are appropriate image gathering optics.

For detection of images formed by the various optical systems, two-dimensional, imaging focal plane array (FPA) detectors are typically employed. The choice of FPA detector is governed by the spectroscopic technique employed to characterize the sample of interest. For example, silicon (Si) charge-coupled device (CCD) detectors or CMOS detectors are typically employed with visible wavelength fluorescence and Raman spectroscopic imaging systems, while indium gallium arsenide (InGaAs) FPA detectors are typically employed with near-infrared spectroscopic imaging systems.

A variety of imaging spectrometers have been devised for spectroscopic imaging systems. Examples include, without limitation, grating spectrometers, filter wheels, Sagnac interferometers, Michelson interferometers, Twynam-Green interferometers, Mach-Zehnder interferometers, and tunable filters such as acousto-optic tunable filters (AOTFs) and liquid crystal tunable filters (LCTFs). Preferably, liquid crystal imaging spectrometer technology is used for wavelength selection. A liquid crystal imaging spectrometer may be one or a hybrid of the following types: Lyot liquid crystal tunable filter (“LCTF”), Evans Split-Element LCTF, Solc LCTF, Ferroelectric LCTF, Fabry Perot LCTF. Additionally, fixed bandpass and band reject filters comprised of dielectric, rugate, holographic, color absorption, acousto-optic or polarization types may also be used, either alone or in combination with one of the above liquid crystal spectrometers.

A number of imaging spectrometers, including acousto-optical tunable filters (AOTF) and liquid crystal tunable filters (LCTF) are polarization sensitive, passing one linear polarization and rejecting the orthogonal linear polarization. AOTFs are solid-state birefringent crystals that provide an electronically tunable spectral notch pass band in response to an applied acoustic field. LCTFs also provide a notch pass band that can be controlled by incorporating liquid crystal retarders within a birefringent interference filter such as a Lyot filter. Conventional systems are generally bulky and not portable. A handheld chemical imaging sensor capable of performing instant chemical analysis would represent progress in size, weight and cost reduction. Accordingly, there is a need for a handheld, portable and more efficient tunable filter.

Biothreat agents exist in four forms: agents such as anthrax are bacterial spores. Other biothreat agents exist as a vegetative (live) cell such as plague (Yersinia pestis). Another class of biothreat agents includes the virus responsible for diseases such as smallpox and Ebola. The final types of biothreat agent are toxins, chemicals produced by a specific organism that are toxic to humans, such as Ricin and botulism toxin. While these are technically chemical agents since they do not involve a living or dormant organism, they are typically considered as biothreat agents.

A practical biothreat detector must be able to identify as many different types of agents as possible. Ideally, it should cover agents in each of the four groups and should do so without the operator having any idea of which agent is present. This desired requirement effectively rules out the use of organism/toxin-specific reagents as used in DNA typing (e.g., PCR) and immunoassay techniques. Therefore, an approach to bioagent detection with no or minimal reagents or sample preparation is preferable in order to meet the needs of the first responder.

A practical bioagent detector should preferably identify the presence of an agent in the presence of all of the other materials and chemicals present in the normal ambient environment. These materials and chemicals include dusts, pollen, combustion by-products, tobacco smoke, and other residues, as well as organisms normally present in water and soil. This detection specificity is desirable to avoid a false positive that can elevate a hoax into an apparent full-blown disaster, such as from a weapon of mass destruction.

Currently, analytes in a solution (e.g., a solvent-based composition) or suspension (e.g., in a fluid, including air or water) are applied to a surface (e.g., a slide for chemical imaging) using applicators that require manual operation. One example of a manual applicator is a syringe or vial type mechanism which may be used to manually apply a fluid-based analyte suspension onto a surface. The fluid (e.g., water) may eventually evaporate from the surface thereby leaving behind the analytes for chemical imaging. Besides being manual in nature, such methods are inefficient and have varying levels of precision. The analyte deposition may not be focused well on the surface resulting in significant waste of the solution/suspension at hand. Furthermore, the applicator may get clogged from frequent use, thereby necessitating manual cleaning of it before further use. Thus, there is a need to reduce the required human intervention and attendant inefficiencies inherent in current state of the art procedures and systems.

### SUMMARY OF THE DISCLOSURE

Instead of manual applicators, the present disclosure contemplates using an ultrasonic nozzle to deposit analytes for chemical imaging. The nozzle allows for automated and efficient deposition without the clogging problem. Additionally, human involvement may be minimized. In one embodiment, a wet wall cyclone collector may be connected to a water tank and used to provide the analyte-containing fluid to the ultrasonic nozzle's liquid inlet port. The nozzle may also contain a compressed air inlet to “focus” the deposition of the fluid input onto the application surface.

Ultrasonic spray devices, such as those manufactured by Sono-Tek Corporation of Milton, N.Y., are contemplated for use in the present disclosure. In accordance with certain embodiments of the present disclosure, an ultrasonic spray device may be used to perform a plurality of spray applications over the same spatial location on, for example, a slide so as to increase the analyte concentration in the desired field of view.

The disclosure applies to deposition of any analytes or organisms of interest in chemical imaging applications and is not restricted to biothreat detection applications.

### BRIEF DESCRIPTION OF THE DRAWINGS

FIG. 1 is a schematic diagram of one exemplary ultrasonic nozzle for use with embodiments of the disclosure.

FIG. 2 is a schematic diagram of a different exemplary ultrasonic nozzle for use with embodiments of the disclosure.

FIG. 3 is a schematic diagram of a portion of an ultrasonic nozzle, such as shown in FIG. 1, illustrating the compressed air focusing section of the nozzle for use with embodiments of the disclosure.

FIG. 4 is a schematic diagram of a portion of an ultrasonic nozzle, such as shown in FIG. 2, illustrating the compressed air focusing section of the nozzle for use with embodiments of the disclosure.

FIGS. 5A and 5B are schematic illustrations of an analysis system according to embodiments of the present disclosure.

FIG. 6 is a flow chart illustrating the steps of one embodiment of the disclosure.

FIG. 7 is a flow chart illustrating the steps of a different embodiment of the disclosure.

### DETAILED DESCRIPTION

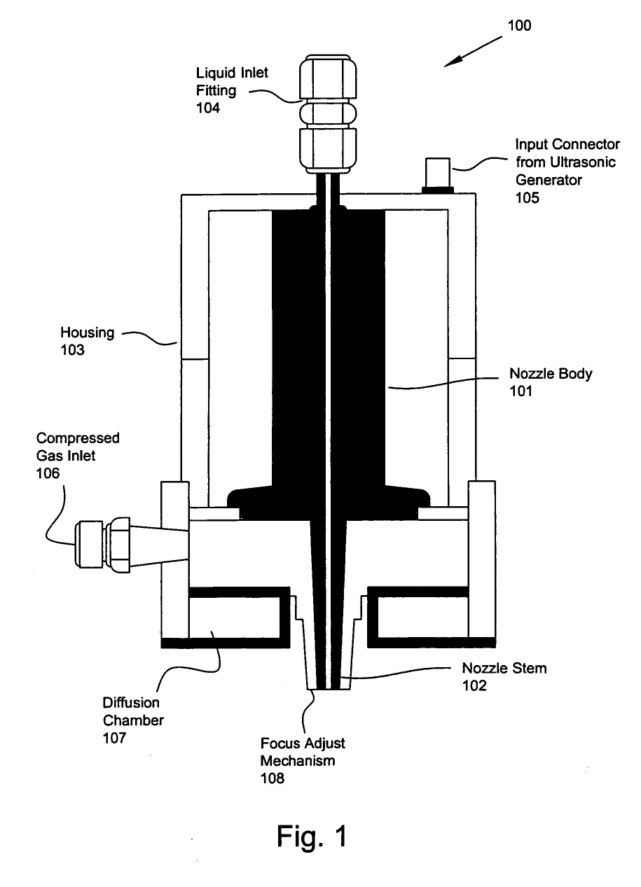

FIG. 1 is a schematic representation of one exemplary ultrasonic nozzle 100 for use with embodiments of the disclosure, such as an ultrasonic spray device manufactured by Sono-Tek Corporation of Milton, N.Y., which is contemplated for use in the present disclosure. The nozzle body 101 is connected to the nozzle stem 102 and is contained within the housing 103. A liquid inlet fitting 104 is operatively connected to the nozzle body. An input connector 105 from an ultrasonic generator is operatively attached to the housing. A compressed gas inlet 106 is operatively connected to a diffusion chamber 107 which is operatively connected to a focus adjust mechanism 108 for focusing the output of the nozzle stem 102 for depositing an analyte on, for example, a slide or other surface.

The liquid inlet fitting 104 is operatively connected to a source for supplying analytes (not shown) such as a liquid-containing vessel (e.g., a water tank containing an analyte solution), a pressurized liquid-containing vessel, or other similar device. Optionally, there may be a conventional wet wall cyclone collector (not shown) operatively connected to a liquid source for providing an analyte-containing fluid to the nozzle 100 via the liquid inlet fitting 104.

The input connector 105 is operatively connected to an ultrasonic generator (not shown) to supply the nozzle 100 with ultrasonic energy.

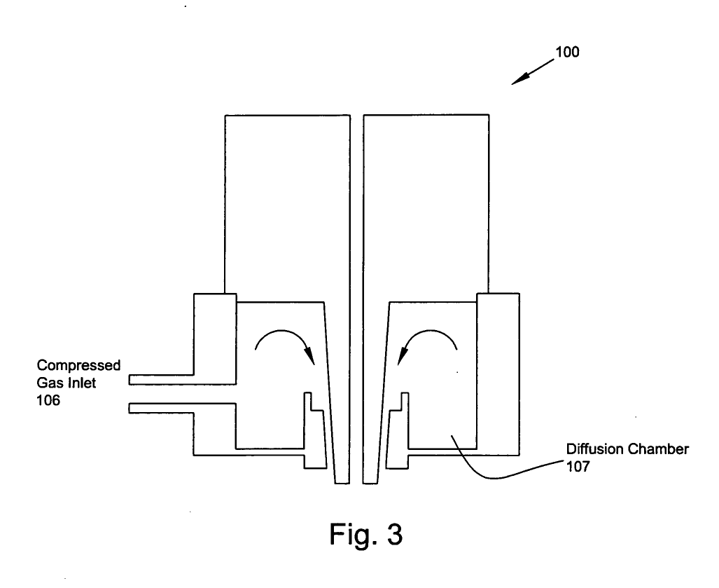

The compressed gas inlet 106 is operatively connected to a compressed gas source (not shown), such as a compressed air tank or air compressor, as non-limiting examples. Compressed gas is supplied to the nozzle 100 via the compressed gas inlet 106 which is directed to the diffusion chamber 107. The compressed gas is then controlled by the focus adjust mechanism 108 as shown in FIG. 3 and described further below.

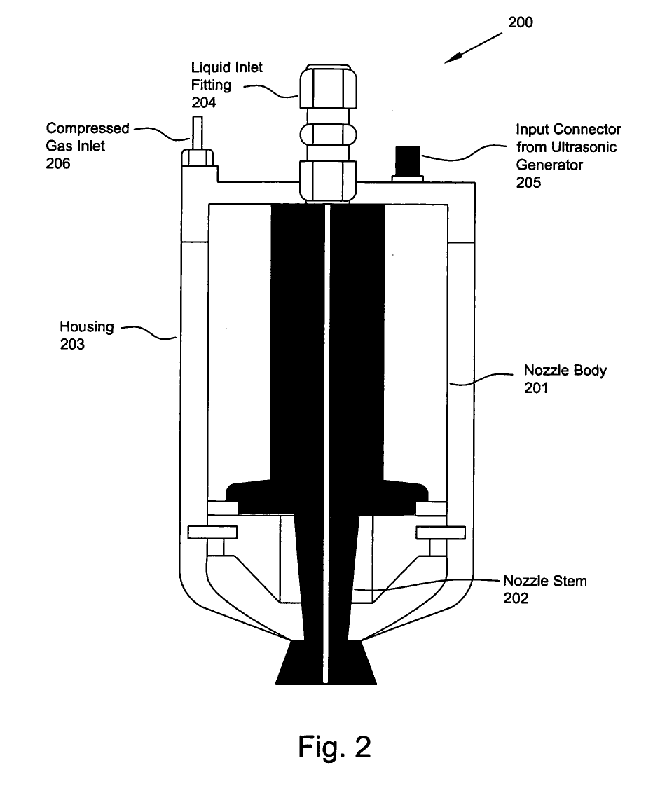

FIG. 2 is a schematic representation of another exemplary ultrasonic nozzle 200 for use with embodiments of the disclosure, such as an ultrasonic spray device manufactured by Sono-Tek Corporation of Milton, N.Y., which is contemplated for use in the present disclosure. The nozzle body 201 is connected to the nozzle stem 202 and is contained within the housing 203. A liquid inlet fitting 204 is operatively connected to the nozzle body. An input connector 205 from an ultrasonic generator is operatively attached to the housing. A compressed gas inlet 206 is operatively connected to a jet block 207 for focusing the output of the nozzle stem 202 for depositing an analyte on, for example, a slide or other surface.

The liquid inlet fitting 204 is operatively connected to a source for supplying analytes (not shown) such as a liquid-containing vessel (e.g., a water tank containing an analyte solution), a pressurized liquid-containing vessel, or other similar device. Optionally, there may be a conventional wet wall cyclone collector (not shown) operatively connected to a liquid source for providing an analyte-containing fluid to the nozzle 100 via the liquid inlet fitting 204.

The input connector 205 is operatively connected to an ultrasonic generator (not shown) to supply the nozzle 200 with ultrasonic energy.

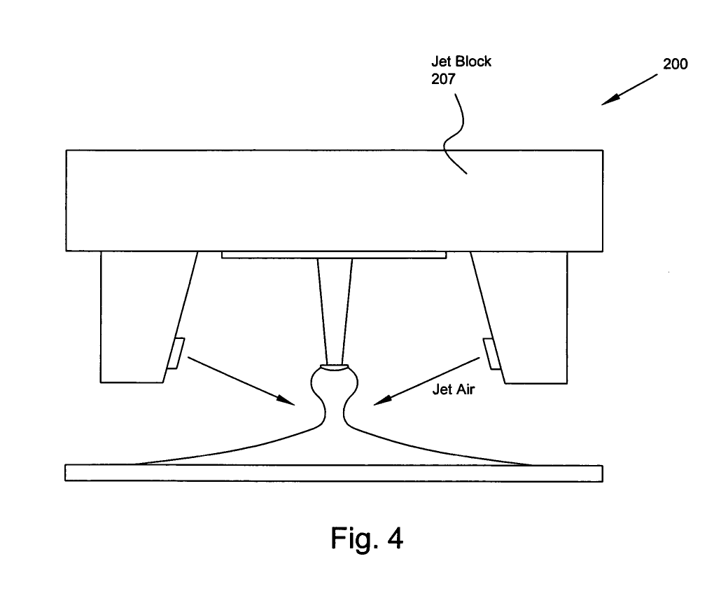

The compressed gas inlet 206 is operatively connected to a compressed gas source (not shown), such as a compressed air tank or air compressor, as non-limiting examples. Compressed gas is supplied to the nozzle 200 via the compressed gas inlet 206 which is directed to the jet block 207 for focusing the output of the nozzle stem 202 as shown in FIG. 4 and described further below.

FIGS. 3 and 4 are schematic diagrams of a portion of an ultrasonic nozzle, such as nozzle 100 shown in FIG. 1 or nozzle 200 shown in FIG. 2. FIG. 3 illustrates the compressed gas focusing section of, for example, the nozzle 100. As described above, the compressed gas inlet 106 is operatively connected to a compressed gas source (not shown). Compressed gas is directed to the diffusion chamber 107. The compressed gas is then controlled by the focus adjust mechanism 108 as shown in FIG. 1 to thereby focus, or de-focus, the output of the nozzle 100. The gas flow from the diffusion chamber 107 can be directed in the same direction as the liquid flow from the nozzle 100, as shown, or can be directed in the opposite direction as the liquid flow from the nozzle 100. FIG. 4 illustrates the compressed gas focusing section of, for example, the nozzle 200. The compressed gas inlet 206, as shown in FIG. 2, is operatively connected to a compressed gas source (not shown). Compressed gas is directed to the jet block 207 for focusing or defocusing the output of the nozzle 200. The gas flow may be directed perpendicular to the liquid flow from the nozzle 200.

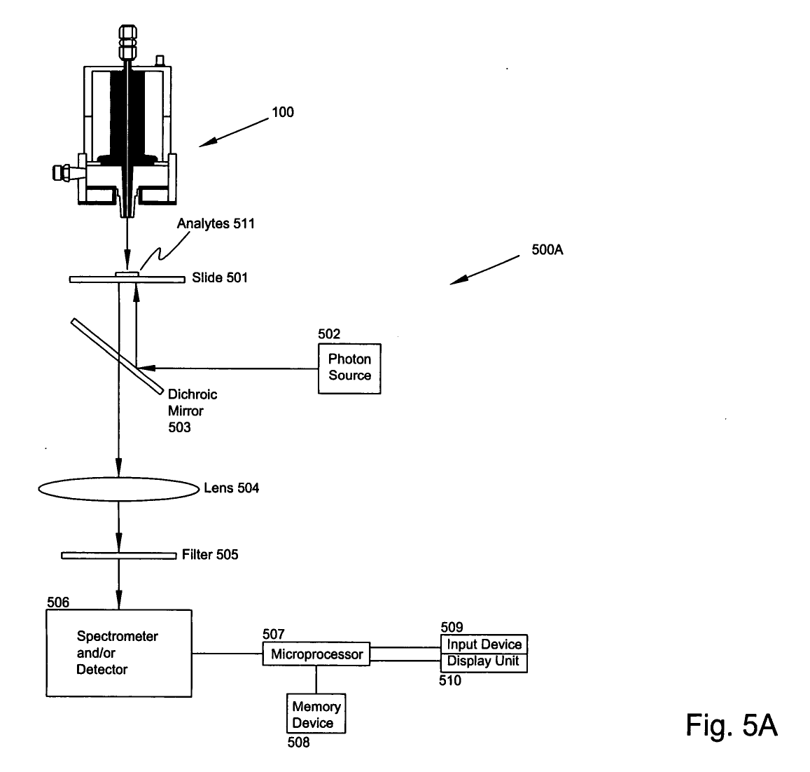

FIGS. 5A and 5B illustrate notional schematic illustrations of an analysis system, 500A and 500B, respectively, according to embodiments of the present disclosure. One of skill in the art will understand that embodiments of the disclosure are not to be limited by the apparent physical arrangement of elements in the schematic illustrations shown and that the physical arrangement of elements shown is non-limiting to the scope of the disclosure.

FIG. 5A illustrates an embodiment of an analysis system 500A. An ultrasonic nozzle 100, such as described above with respect to FIG. 1, deposits analytes 511, or an analyte-containing solution or suspension, for example, onto a surface such as the slide 501. More than one deposition of analytes may be preferred in order to ensure a sufficient sample of analytes on the surface. A photon source 502 illuminates the analytes 511 with first photons via the dichroic mirror 503. The liquid in the analyte-containing solution or suspension has preferably been evaporated. The analytes may be biothreat agents, bacterial spores, live cells, virus, toxins, protozoan, protozoan cyst, combinations of the foregoing, or other substances for which a spectral image or chemical image is desired to be obtained. The first photons from the photon source 502 may have a wavelength in a range of wavelengths associated with white light, near infrared light, infrared light, ultraviolet light, or a combination of the foregoing. Additionally, the photon source 502 may be a laser. The first photons interact with the analytes 511 in a number of ways as is known in the art including, but not necessarily limited to, scattering, Raman scattering, reflection, or causing emission, to produce second photons which are collected by the lens 504, perhaps after passing through the dichroic mirror 503. One of skill in the art would readily understand that the optical path traversed by the first and second photons may be designed such that the dichroic mirror 503 need not be present. There may be some first photons in the optical path with the second photons. The filter 505 blocks substantially all of these first photons in the optical path with the second photons while allowing substantially all of the second photons to pass therethrough. The second photons that pass through the filter 505 enter a photon detector 506 which preferably includes a spectrometer, and/or a charge-coupled device, so as to obtain a spectral analysis of the analytes. Non-limiting examples of the spectrometer include a diffraction grating, a prism, grating spectrometers, filter wheels, Sagnac interferometers, Michelson interferometers, Twynam-Green interferometers, Mach-Zehnder interferometers, and tunable filters such as acousto-optic tunable filters (AOTFs) and liquid crystal tunable filters (LCTFs). The spectrometer may also be a liquid crystal imaging spectrometer and may be one or a hybrid of the following types: Lyot liquid crystal tunable filter (“LCTF”), Evans Split-Element LCTF, Solc LCTF, Ferroelectric LCTF, Fabry Perot LCTF.

The photon detector 506 may send a signal representative of the spectral analysis of the analytes 511 to a microprocessor 507 for processing of the signal. The microprocessor, or a second microprocessor (not shown) may compare the spectral analysis of the sample to a spectrum of a biothreat agent stored in a memory device 508. A display unit 510 may display the signal from the photon detector 506, a signal from the microprocessor 507, and/or a signal from the memory device 508. A user of the analysis system may utilize an input device 509, for example a keyboard or a pointing device such as a mouse, for controlling the operation of the analysis system. In one embodiment of the disclosure, the display unit 510 and the input device 509 may be an integrated unit, such as a touch-screen display.

FIG. 5B illustrates an embodiment of an analysis system 500B, which operates in a similar manner as the analysis system 500 A described above. The analysis system 500B has the nozzle 100 offset so that the photon source 502 can supply first photons to the analytes 511 from above. After deposition of the analytes 511 onto the slide 501, the slide can be moved from the position under the nozzle 100 by either conventional automatic or manual means, such as, but not limited to, a conveyor belt, a geared mechanism, or other similar device. Alternatively, the slide 511 can remain stationary and the nozzle 100 and/or the photon source 502 can be moved, pivoted, or swung out/in so that the nozzle 100 and the photon source 502 do not interfere with each other's operation.

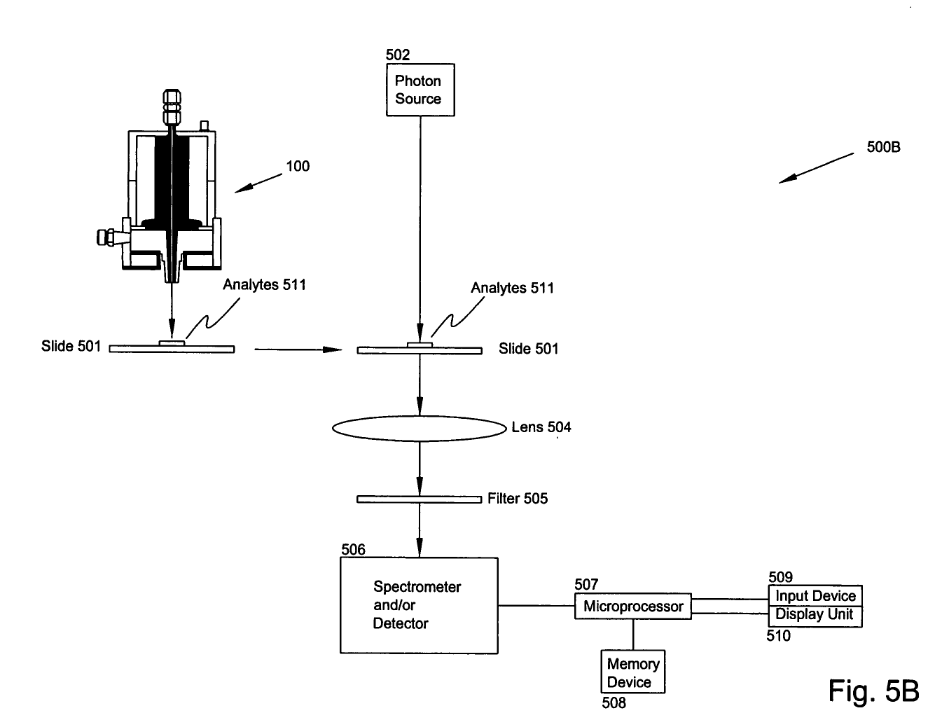

FIG. 6 is a flow chart illustrating the steps of one embodiment of the disclosure. In step 601, an analyte-containing fluid is supplied to an ultrasonic nozzle. In step 603 the ultrasonic nozzle deposits analytes on a surface, such as a slide. This step may be repeated in order to ensure a sufficient amount of analyte on the surface.

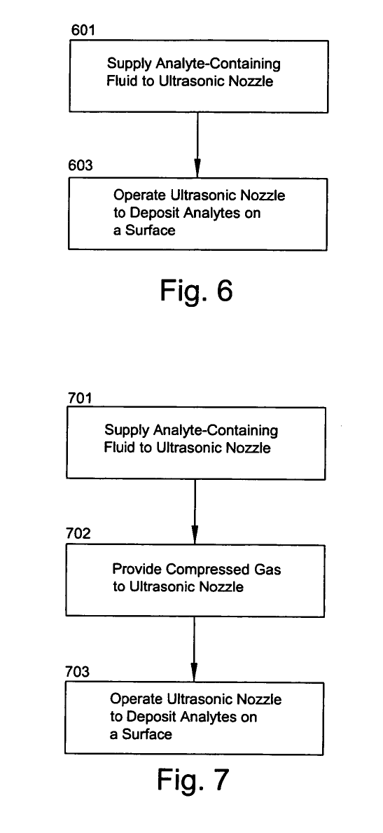

FIG. 7 is a flow chart illustrating the steps of a different embodiment of the disclosure. In step 701, an analyte-containing fluid is supplied to an ultrasonic nozzle. In step 702, compressed gas is provided to the ultrasonic nozzle to as to focus or defocus the output spray of the nozzle. In step 703 the ultrasonic nozzle deposits analytes on a surface, such as a slide. This step may be repeated in order to ensure a sufficient amount of analyte on the surface.

The above description is not intended and should not be construed to be limited to the examples given but should be granted the full breadth of protection afforded by the appended claims and equivalents thereto. Although the disclosure is described using illustrative embodiments provided herein, it should be understood that the principles of the disclosure are not limited thereto and may include modification thereto and permutations thereof.

I claim:

1. A method of analyte deposition for chemical imaging, comprising the steps of:
(a) supplying an analyte-containing fluid to a liquid inlet port of an ultrasonic nozzle; and
(b) operating said ultrasonic nozzle to deposit analytes on a surface selected for chemical imaging of said analytes.

2. The method of claim 1 further comprising the step of:
(c) providing compressed gas to a gas inlet port of said ultrasonic nozzle such that the step of operating the nozzle includes regulating a flow of said compressed gas so as to control a focus of analyte deposition on said surface.

3. The method of claim 1 wherein the step of operating said ultrasonic nozzle causes said analytes to be deposited in a first location on said surface and the step of operating said ultrasonic nozzle is repeated at least once so as to have multiple depositions of said analyte in said first location.

4. A system for obtaining a spectrum of an analyte, comprising:
an ultrasonic nozzle for spraying said analyte on a surface;
a photon source for providing a first plurality of photons to said analyte;
a first optical lens for collecting a second plurality of photons from said analyte;
a filter for blocking a portion of said first plurality of photons present in an optical path with said second plurality of photons; and
a photon detector to thereby obtain a spectrum of said analyte.

5. The system of claim 4 further comprising a spectrometer.

6. The system of claim 5 wherein said spectrometer is selected from the group consisting of: diffraction grating, prism, and liquid crystal tunable filter.

7. The system of claim 4 wherein said photon detector is a charge-coupled device.

8. The system of claim 4 further comprising a first microprocessor for analyzing an output signal from said photon detector.

9. The system of claim 8 further comprising a memory device for storing a spectrum of a biothreat agent.

10. The system of claim 9 further comprising a second microprocessor for comparing an output signal from said photon detector with the stored spectrum in said memory device.

11. The system of claim 10 further comprising a display unit for displaying information based on said comparison.

12. The system of claim 11 further comprising a device for accepting input from a user.

13. The system of claim 4 wherein said first plurality of photons have a wavelength in a range of wavelengths selected from the group consisting of: white light, near infrared light, infrared light, and ultraviolet light.

14. The system of claim 4 wherein said second plurality of photons comprise photons scattered by said analyte.

15. The system of claim 14 wherein said scattered photons are Raman scattered photons.

16. The system of claim 4 wherein said second plurality of photons comprise photons emitted by said analyte.

17. The system of claim 4 wherein said second plurality of photons comprise photons reflected by said analyte.

18. The system of claim 4 wherein said analyte comprises material which is selected from the group consisting of: biothreat agents, bacterial spores, live cells, virus, toxins, protozoan, protozoan cyst, and combinations thereof.

19. The system of claim 4 including a wet wall cyclone collector operatively connected to a water source for providing an analyte-containing fluid to said ultrasonic nozzle.

20. The system of claim 4 wherein said ultrasonic nozzle includes a gas inlet port configured to supply compressed gas therethrough so as to control said analyte spraying on said surface.

21. A method for obtaining a spectrum of an analyte, comprising:
(a) spraying an analyte on a surface using an ultrasonic nozzle;
(b) illuminating said analyte with a first plurality of photons to thereby produce a second plurality of photons;
(c) collecting said second plurality of photons;
(d) blocking a portion of said first plurality of photons present in an optical path with said second plurality of photons; and
(e) directing said second plurality of photons to a photon detector to thereby obtain a spectrum of said analyte.

22. The method of claim 21 further comprising the step of:
(f) directing said second plurality of photons to a spectrometer.

23. The method of claim 21 further comprising the steps of:
(g) storing a predetermined spectrum of a biothreat agent in a memory device;
(h) comparing an output signal from said photon detector with the stored spectrum; and
(i) displaying information based on said comparison.

24. The method of claim 21 wherein the step of spraying an analyte on a surface using an ultrasonic nozzle is repeated a plurality of times to thereby increase the analyte concentration on said surface.
